(19) United States
(12) Patent Application Publication
(10) Pub. No.: US 2015/0127420 A1
(43) Pub. Date: May 7, 2015

(54) DETERMINING VELOCITY DATA FOR CONTACT

(71) Applicant: BANK OF AMERICA CORPORATION, CHARLOTTE, NC (US)

(72) Inventors: MICHAEL D. FLEISCHER, DOUBLE OAK, TX (US); RYAN SCOTT HELLER, MIDDLETOWN, DE (US); HUDSON PHILIP HOEN, IV, WILMINGTON, DE (US); PATRICK B. SMITH, GARLAND, TX (US); HARI MADALA, PITTSBURGH, PA (US); SETHU IYER, KENNETT SQUARE, PA (US); ANDREW SHELDON, MOUNTAIN TOP, PA (US); MICHAEL JOHN BLATTEAU, JR., TOWNSEND, DE (US); RICHARD HARDIN STATON, BROOMALL, PA (US)

(73) Assignee: BANK OF AMERICA CORPORATION, CHARLOTTE, NC (US)

(21) Appl. No.: 14/071,995

(22) Filed: Nov. 5, 2013

(51) Int. Cl. G06Q 30/02

(52) U.S. Cl. CPC G06Q 30/0201
USPC 705/7.29

(57) ABSTRACT

Embodiments of the disclosure relate to systems, methods, and computer program products for determining velocity data. The system, method, and computer program product are configured to determine one or more contacts for a customer; determine a number of communication attempts to the one or more contacts over a predetermined time period; compare the number of communication attempts over the predetermined time period to a maximum number of attempts over the predetermined time period; and exclude the customer from a contact list when the number of communication attempts is greater than or equal to the maximum number of communication attempts for the predetermined time period. The system allows a user to track the total number of contacts across a variety of metrics in order to comply with business decisions and local rules.

### BACKGROUND

Representatives of institutions, such as financial institutions, often contact customers for various reasons. For example, an institution may contact a customer regarding a specific account or to provide a special offer. Institutions, however, want to efficiently contact customers while complying with business policies and rules. Many different policies affect whether a customer should be contacted, including the frequency of contact, requests by customers, and general information relating to customers' lives. In particular, frequency of contact is determined by institutions in order to appropriately contact customers.

For these reasons, there is a need for a system that tracks the frequency of contact for customers, accounts, and contacts.

### SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

In a first aspect, a system for determining velocity data is provided, the system including a computer apparatus including a processor and a memory; and a software module stored in the memory, comprising executable instructions that when executed by the processor cause the processor to: determine one or more contacts for a customer; determine a number of communication attempts to the one or more contacts over a predetermined time period; compare the number of communication attempts over the predetermined time period to a maximum number of attempts over the predetermined time period; and exclude the customer from a contact list when the number of communication attempts is equal to or greater than the maximum number of communication attempts for the predetermined time period.

In some embodiments, the module is further configured to: determine a number of attempted contacts for the customer; determine a number of attempted contacts for an account associated with the communication; determine a number of attempted contacts for the one or more contacts; and exclude the customer when any one of the number of attempted contacts for the customer, the number of attempted contacts for the account, and the number of attempted contacts for the one or more contacts is equal to or greater than the maximum number of communication attempts for the predetermined period of time. In still further embodiments, the customer is determined based on selection criteria. In some embodiments, the system includes executable instructions that when executed by the processor cause the processor to: provide a representative with the number of attempted contacts in the predetermined time period. In still further embodiments, the system includes executable instructions that when executed by the processor cause the processor to: provide a representative with the difference between the number of attempt contacts in the predetermined time period and the maximum number of contacts in the predetermined time period.

The system may include determining that the contact is excluded based on velocity comprises determining a frequency of contact associated with the customer, comparing the frequency of contact associated with the customer with a database of currently prohibited frequencies, and excluding the contact based on the comparison between the frequency of contact of the customer and the database of currently prohibited frequencies. In some embodiments, the maximum number of communication attempts is determined based on at least one of a business decision and a jurisdictional rule.

In a second aspect, a computer program product for determining velocity data is provided, the computer program product including a non-transitory computer readable storage medium having computer readable program code embodied therewith, the computer readable program code comprising: a computer readable program code configured to determine one or more contacts for a customer; a computer readable program code configured to determine a number of communication attempts to the one or more contacts over a predetermined time period; a computer readable program code configured to compare the number of communication attempts over the predetermined time period to a maximum number of attempts over the predetermined time period; and a computer readable program code configured to exclude the customer from a contact list when the number of communication attempts is equal to or greater than the maximum number of communication attempts for the predetermined time period.

9. The computer program product of claim 8, the computer program product further comprising a computer readable program code configured to determine a number of attempted contacts for the customer; determine a number of attempted contacts for an account associated with the communication; determine a number of attempted contacts for the one or more contacts; and exclude the customer when any one of the number of attempted contacts for the customer, the number of attempted contacts for the account, and the number of attempted contacts for the one or more contacts is equal to or greater than the maximum number of communication attempts for the predetermined period of time.

In a third aspect, a method for determining velocity data is provided, the method including determining, via a computing device processor, one or more contacts for a customer; determining, via a computing device processor, a number of communication attempts to the one or more contacts over a predetermined time period; comparing the number of communication attempts over the predetermined time period to a maximum number of attempts over the predetermined time period; and excluding the customer from a contact list when the number of communication attempts is equal to or greater than the maximum number of communication attempts for the predetermined time period.

Other aspects and features, as recited by the claims, will become apparent to those skilled in the art upon review of the following non-limited detailed description of the invention in conjunction with the accompanying figures.

### BRIEF DESCRIPTION OF THE DRAWINGS

Having thus described embodiments of the invention in general terms, reference will now be made to the accompanying drawings, which are not necessarily drawn to scale, and wherein:

FIG. 1 provides a high level process flow illustrating the unified recovery process, in accordance with one embodiment of the present disclosure;

FIG. 2 provides a high level process flow illustrating the unified recovery system process, in accordance with one embodiment of the present disclosure;

FIG. 3 is a flow diagram illustrating a high-level process flow for a system and method for determining an automatic contact list, in accordance with embodiments of the disclosure;

FIG. 4 is a block diagram illustrating exemplary technical components of a financial institution banking system, in accordance with an embodiment of the present disclosure;

FIG. 5 is a block diagram illustrating exemplary technical components of a system for determining an automatic contact list, in accordance with an embodiment of the present disclosure;

FIG. 6 is a flow diagram illustrating a process flow for a system and method for determining velocity data, in accordance with an embodiment of the present disclosure; and

FIG. 7 is a diagram representing exemplary maximum number of communication attempts related to customer velocity, account velocity, and contact velocity, in accordance with an embodiment of the disclosure.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” It should also be understood that while some embodiments describe the methods or products as comprising one or more elements, the methods or elements may also consist of or consist essentially of the elements disclosed herein.

Although embodiments of the present invention described herein are generally described as involving a merchant, it will be understood that merchant may involve one or more persons, organizations, businesses, institutions and/or other entities such as financial institutions, services providers that implement one or more portions of one or more of the embodiments described and/or contemplated herein.

Apparatus, systems, methods and computer program products are herein disclosed for determining an automatic contact list. Inasmuch as financial institutions determine automatic contact lists in order to efficiently contact customers while complying with business and legal requirements, specific embodiments disclosed herein relate to financial institutions. However, such embodiments are exemplary.

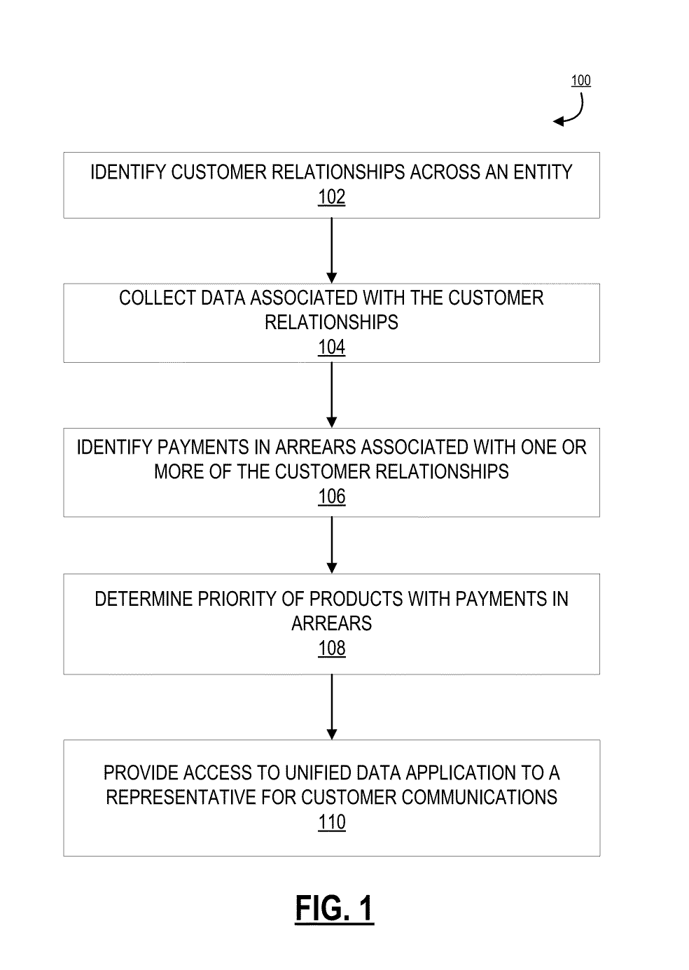

FIG. 1 illustrates a high level process flow for a unified recovery process 100 in which the automatic contact lists may be used. As illustrated in block 102, the process 100 begins with identifying customer relationships across an entity. In this way, the system may identify all products that a customer may have with the entity across one or more lines of business within the entity. As such, addresses, affiliates, phone numbers, customer products, products with payments that are in arrears, and any other information that may be associated with a single customer may be gathered across the lines of business of an entity. Next, as illustrated in block 104, the data associated with the customer relationships may be collected and compiled in association with the customer. As such, all relationship data may be stored in association with a customer including those products and/or accounts that are in arrears.

The next step in the process 100, as illustrated in block 106, is to identify payments in arrears associated with the customer. As such, the products or accounts that have payments in arrears that are associated with that particular customer are identified. A product or account with a payment in arrears may be qualified as being in arrears based on the entity itself and/or agreements for payment between the customer and the entity. For example, after the due date for payment for the product or after a predetermined number of days after the due date, the product may be considered by the entity to be in arrears. Furthermore, the accounts or products with payments in arrears for people affiliated with that customer, such as when the customer is a guarantor for the associate or the like, may also be identified by the system. People affiliated with the customer may include friends, family, or the like associated with the customer.

As illustrated in block 108, the system determines the priority of the products with payments in arrears. In this way, the system may determine which products in arrears should take priority over the other products for purposes of recovery of payments. The primary account for recover is the account or product that the entity has identified as having payment in arrears that is the one which needs to be recovered first. This may be based on entity determination, interest rate, amount, importance, or the like. As such, the system may identify the products with payments in arrears that are the most important to recover first ahead of the other payment products. Thus, the representative may focus on recovering payments for that identified product.

Finally, as illustrated in block 110, the process 100 continues by providing access to a unified application to a representative for customer communications. The unified application provides the representative with an across the entity view of the customer's relationship with the entity as well as information associated with the primary account and other accounts with payments in arrears. The unified application may also use the system and method for the automatic contact list generation in order to develop contact lists that representatives or teams of representatives communicate with efficiently and while complying with business and legal requirements. Finally, the unified application also provides information associated with prior customer communications. As such, the invention provides a holistic customer service experience for a customer with accounts in arrears.

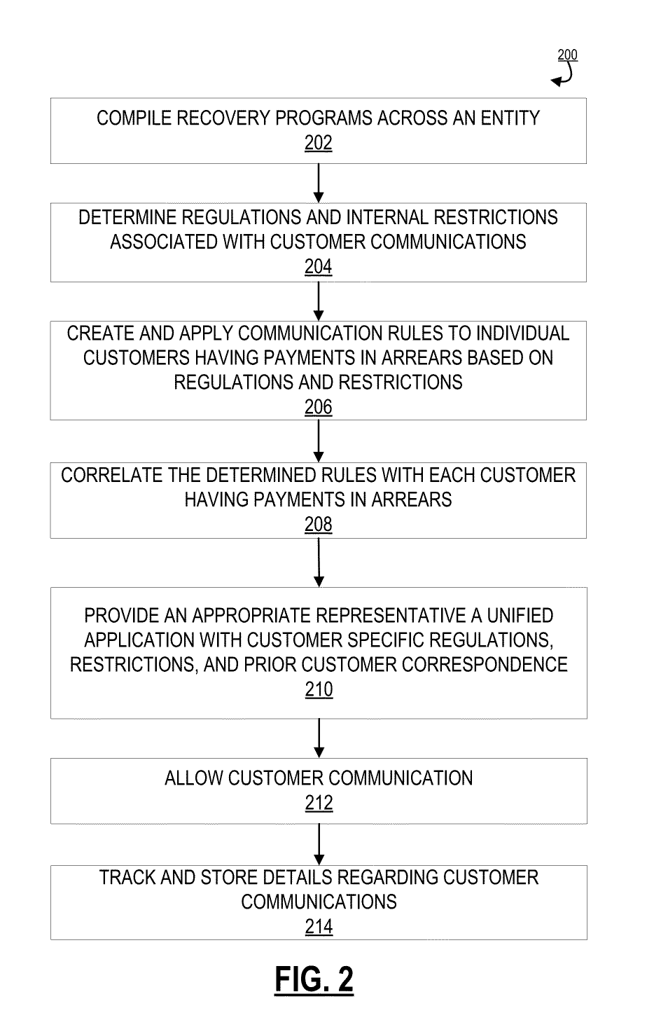

FIG. 2 illustrates a high level process flow for the unified recovery system process 200, in accordance with one embodiment of the present disclosure. The process 200 describes a high level of the unified recovery system's steps to providing a representative with the unified application to aid in payment in arrears recovery. First, as illustrated in block 202, the system compiles the various recovery programs across the entity. In this way, all recovery programs may be centralized, such that the representative can log into a single system. This eliminates requiring the representative to log into a plurality of software programs in order to view and understand all relationships a customer has with the entity.

Next, as illustrated in block 204, the system may determine regulations and internal restrictions associated with individual customer communications. Regulations may include laws or other regulations regarding the time of day a customer may be contacted, the amount of times within a given day/week/month that a customer may be contacted, a telephone number in which a customer may be contacted, or the like. As such, the system ensures that the representative is following all regulations and/or laws regarding the contacting of customers with products having payments in arrears. Internal regulations may include any rule that an entity may put in place to restrict or warn a representative prior to the representative contacting a customer or during the representative's communication with the customer. For example, an internal regulation may be set based on a customer communication preference, such as a specific telephone number to utilize for communications with the customer. In another example, the entity may identify an event that requires the entity to delay in communicating with a customer regarding a product with a payment in arrears (e.g., a natural disaster in the geographic are where the customer is located or another known event that may interfere with a customer providing payment).

In some embodiments, the regulations or restrictions may, in some instances, be overridden by the representative. In this way, the representative may still contact the customer even if a regulation or restriction is in place. The representative may need to input a reason for overriding the regulation or restriction. In some embodiments, the regulation or restriction may not be overridden by any representative. In this way, the system will not allow the representative to communicate with the customer at that time. In some embodiments, no regulation or restriction may be placed on a customer communication. As such, the representative may contact the customer at any time.

Next, as illustrated in block 206 the system may utilize the regulations and restrictions to create rules for customer communications. These rules may be created and applied to a customer on a customer-by-customer basis. In this way, each customer, based on the customer's location, telephone number, or the like, may have a unique set of rules applied for him/her based on regulations and/or restrictions that may apply to the customer having payments in arrears for products. Next, once the rules have been created and applied in block 206, the determined rules may be correlated with each individual customer having payments in arrears, as illustrated in block 208. In some embodiments, the system to determine permission to contact is also used to determine rules for when a customer may be contacted.

As illustrated in block 210 of FIG. 2, the system may provide a unified application for displaying a customer relationship to an appropriate representative. The unified application has specific regulations, restrictions, and prior customer correspondence associated therewith. An appropriate representative may be identified by the system based on which representative has experience with that particular customer, knowledge with a particular account in arrears, or general expertise regarding a field associated with the primary account for recovery. The system may identify and match the customer with the appropriate representative based on these factors.

Next, as illustrated in block 212 the system may allow the representative to initiate a communication with the customer. Allowing the representative to initiate a communication with a customer may be based on the determined regulations and restrictions. In some embodiments, the regulations and restrictions will not allow a representative to communicate with the customer. In some embodiments, the regulations and restrictions will warn against communicating with the customer. However, a representative may be able to override the warning. In some embodiments, the regulations and restrictions will allow a representative to communicate with the customer.

Finally, as illustrated in block 214, the system may track and store details regarding the customer communications. In this way, the system may track the disposition of the communication, such as determining if a communication was answered by the customer, a busy signal was received, or that the customer answered the communication. The system may identify the date, time, means of communication (such as specific telephone number, email address, or the like). Furthermore, the system may store any comments or notes made by the representative during the communications.

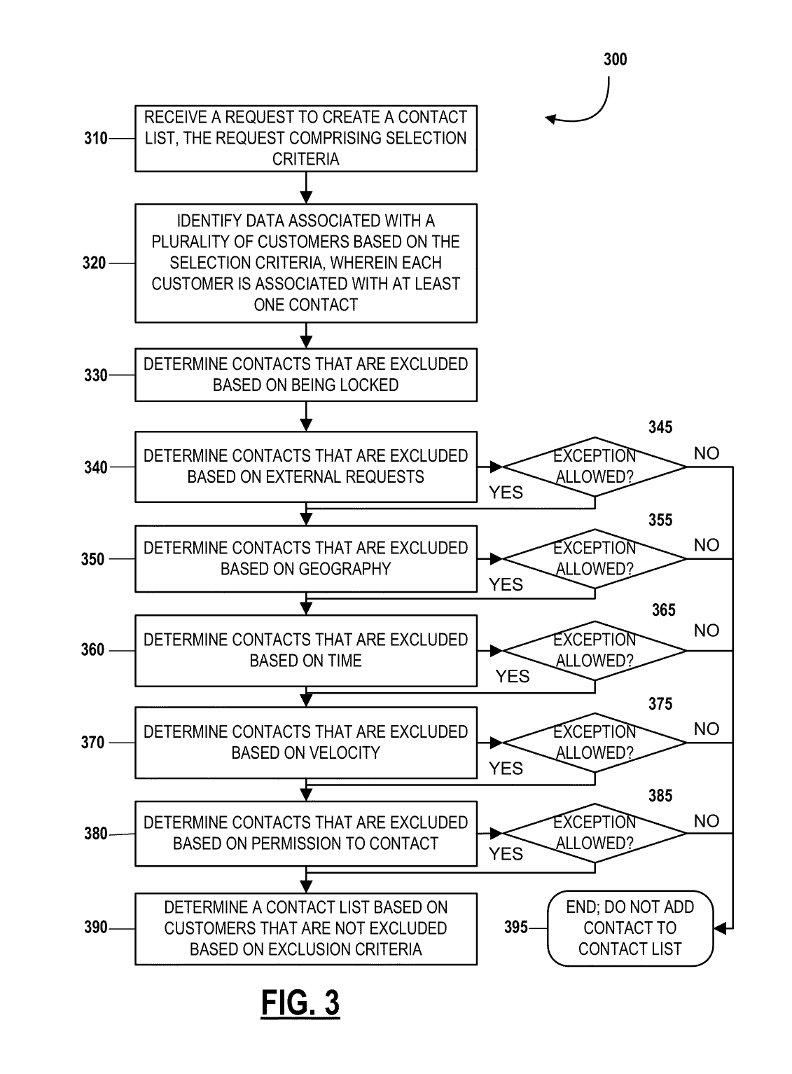

FIG. 3 illustrates a general process flow 300 for an apparatus or system for determining an automatic contact list consistent with an embodiment of the present disclosure. In some embodiments, the system receives a request to create a contact list, the request comprising selection criteria; identifies data associated with a plurality of customers meeting the selection criteria, wherein each customer is associated with at least one contact; determines contacts that are excluded based on at least one of locking, external requests, geography, time, velocity, and permission to contact; and determines a contact list based on customers that are not excluded.

As shown in block 310, the system receives a request to create a contact list, the request comprising selection criteria. A contact list is a list of customers that a representative of an institution (e.g., a financial institution) or a team of representatives will contact. In an embodiment, the contact list includes an order, such as a first customer to be a contacted, a second customer to be contacted, and the like. In a further embodiment, the contact list is not ordered. That is, while the contact list may include a plurality of customers, there is no reason or intention to contact the customers in a specific order.

The contact list may also information related to the customer. For example, the contact list may include financial account information, e.g., balances, debits, delinquencies, amounts in arrears, and the like. Additionally, the contact list may include demographic information, communication information, preferences, and other information relating to the customer and interactions between the customer and the institution. With respect to preferences, the contact list may include the customer's preferences, such as preferred name, preferred times to contact, and preferred language.

A contact list is used to assist in communicating with customers, such as in an automatic dialing campaign. The contact list may be portable, such that the contact list can be implemented on various communication devices (e.g., an automatic dialer, a voicemail campaign, an email campaign, a direct mail campaign, and the like). In another embodiment, the contact list is specific to a particular channel, such as a telephone dialer or an email manager.

In an embodiment, the request for the contact list is received from a manager or representative of an institution in order to efficiently contact customers while complying with business and legal rules. The request may be received via a graphical user interface on a computing device. In an embodiment, a representative or manager inputs a request for a contact list into a system and then, after determining the contact list, the system initiates contact with one or more customers on the list.

In an embodiment, the contact list includes selection criteria. Selection criteria are requirements and/or preferences determined by the entity requesting the contact list. For example, a representative may request a contact list comprising Spanish-speaking customers associated with a specific type of category. The selection criteria are selected by the user and input into the system via a graphical user interface.

Selection criteria may include any type of criteria associated with customers, the representatives making the contact, and/or the financial institution. For example, selection criteria may relate to one or more of customer accounts, customer balances, length of time in arrears, customer preferences, representative characteristics, and the like. In one example, the selection criteria are designed to develop a contact list that includes customers sharing one or more characteristics. In this manner, goals of the institution can be met by efficiently communicating with customers on a related topic. For example, the institution may desire to communicate with customers having a specific account more than thirty days in arrears. The user can input these selection criteria, e.g., specific account type and more than thirty days in arrears, into the system in order to begin the process of developing a contact list. As should be understood, a wide variety of selection criteria associated with customer data, including demographics, financial records, bill pay history, transaction types, payment channels, and the like may be used to develop selection criteria.

In block 320, the system receives data associated with a plurality of customers based on the selection criteria, wherein each customer is associated with at least one contact. A plurality of customers is more than one customer. In some embodiments, the customer is a customer of the merchant, e.g., the financial institution communicating with the customer. The customer may have an account or relationship with the merchant. For example, the customer may have a credit card or line of credit with the merchant. In some embodiments, the merchant is communicating with the customer regarding accounts in arrears or discussing recovery of payment in arrears. In further embodiments, the customer is a customer of a third party associated with the merchant. For example, the merchant may be contracted to communicate with the customer by the third party. In a still further embodiment, the customer is a potential customer of the merchant or a third party. The customer may be an individual or an entity such as a business, non-profit, or governmental entity. The customer may have multiple contacts and multiple accounts with the merchant.

The data received may be data associated with the customer's account history, such as records relating to accounts in arrears, demographic information, account numbers, and the like. The data are received over a network and from data sources such as databases associated with a financial institution. The data are used to develop the contact list, such as by determining whether the customer meets the selection criteria.

A contact is a piece of information that allows another party to communicate with the customer. In an embodiment, the contact is channel specific. For example, the contact may be a phone number, e.g., a landline or mobile phone number. The system disclosed herein may be used with various types of contacts, including phone numbers for voice or text messaging, email addresses, private messaging address (such as through a web forum, social network messaging, instant messaging, physical mail, in-person contact, messages provided when logging into merchant websites, messages on ATMs or receipts, and the like.

In some embodiments, the contact is provided by the customer. For example, the customer may enter a phone number into a form when applying for an account. The customer may provide an email address when registering for electronic statements. In further embodiments, the contact is retrieved by the system. For example, the system may determine that a newly opened account does not have a contact phone number associated with it but that the account is related to another account having an associated phone number. The system may also retrieve contacts from publicly-available information, such as databases of contacts for customers, social networks, or the like.

In some embodiments, the contact is determined automatically by the system. For example, the contact may be determined based on criteria associated with the customer. If the customer has an account in arrears, the contact may be determined by the system after a search criteria identifies the account in arrears. In some embodiments, the contact is identified based on search criteria entered by an administrator or representative. For example, the administrator may be creating an autodial campaign for phone numbers based on location, account characteristics, and the like. The system to determine permission to contact can act in the background to provide only those contact phone numbers which the system has permission to contact to the administrator. In this embodiment, search criteria are used to create an autodial list comprising contacts which the system has permission to contact.

In block 330, the system determines contacts that are excluded based on being locked. The system evaluates each contact for the selected customers and determines if the contact, customer, and/or an account associated with the customer is already being contacted. For example, the system will not include a contact on the list if a representative from the financial institution is currently contacting the customer. In some embodiments, the contact is locked if a representative is on the call with the customer. In an embodiment, all contacts for a customer are locked if a representative is currently on the call. In some embodiments, a contact is locked if the contact has been assigned to another contact list via the system but has not yet been contacted.

In an embodiment, the system determines contacts that are locked by comparing the contacts associated with the selected customers to contacts that are currently being worked by the communication system.

When a contact is excluded, the contact is removed from the pool of candidates for the contact list. The contact has been determined to be unsuitable for the contact list because, with respect to locking, the contact, customer, and/or account is already being communicated with by someone or in some way (e.g., messaging) by the institution.

In block 340, the system determines contacts that are excluded based on external requests. An external request is a request from the customer, a third party, or an individual associated with the financial institution. In this manner, external means automatically determined by the system. The external request may be, for example, a request from a customer or attorney to not contact someone, a request to not contact a specific phone number because the contact is incorrect for a specific customer (e.g., the phone number has changed), a cease and desist letter received by the institution, channel specific requests not to contact, contacts associated with the institution itself, specific types of contacts such as phone numbers that incur a per minute charge, 1-800 numbers, general contact numbers for businesses with many employees, and the like.

The external request may be received through various channels based on the reason for being excluded from the contact list. For example, cease and desist letters may be received by another entity in the institution, which then communicates this information to the system. A request from a customer, however, may be communicated directly from the customer during a phone call and the representative can then update the customer's or contact's record to indicate the request.

As with locking, excluding a contact for being excluded based on external requests eliminates the contact from the candidates for the contact list. As the system completes the iterative process of eliminating customers that meet the selection criteria but are excluded based on a characteristic of the customer or contact, the contact list is being constructed. In some embodiments, the order that the iterative process occurs is important because customers can be excluded quickly and while using less processing power based on narrow exclusion criteria than based on broad exclusion criteria. For example, many contacts may be excluded based on external requests compared to the number of contacts that are excluded based on locking. In this situation, the system may first evaluate the selected customers based on external requests and then evaluate the customers based on locking in order to more quickly eliminate customers.

In decision block 345, the system determines whether an exception is allowed. An exception is an override to the rule that a contact should be excluded based on the external request. The user may allow an exception as a batch process for the entire list. For example, the user may determine that all external requests generated by the financial institution in order to roll out a new product may be overridden in order to communicate with the customers. In this manner, general exceptions can be input onto a list to increase the number of customers that may be contacted. In another embodiment, however, exceptions are contact, customer, and/or account specific and are entered by the user for only the specific contact, customer, and/or account.

In an embodiment, any type of exception may be a reason for not excluding a contact from the contact list. For example, a customer may have asked a representative to call the customer at a number that the customer previously submitted a do not call request for. Other examples of exceptions to exclusion based on external requests include system issues, changes in policies, changes in external requests, and the like.

In an embodiment, every exception is tracked and the user inputting the exception is required to give a reason why the exception is being allowed. These reasons are saved in a database along with the record of the communication. In an embodiment, the system develops a graphical user interface, such as a drop down list, the system provides permissible reasons for exceptions to the user and assists the user is selecting the reason. In a further embodiment, the system tailors the drop down list to the reasons why the contact may be excluded.

If the exception is not entered by a user, the contact being evaluated is excluded from the list, as shown in block 395.

Turning now to block 350, the system determines contacts that are excluded based on geography. As with locking and external request, exclusion based on geography evaluates a contact and excludes the contact from the candidates for the contact list if certain criteria are met. For example, an institution may determine that a specific geographic region should not be contacted. The geographic region may be having a holiday or may have had an incident that results in a business decision to not contact customers having accounts in arrears. Similarly, governmental regulations may inform the system that customers should not be contacted within a specific region. For example, a federal agency such as the Federal Emergency Management Agency (FEMA) may provide examples of geographic areas (e.g., zip codes) that are under emergency conditions.

The location of the customer, account, and/or contact may be determined based on the mailing address associated with the contact, with demographic data provided by the customer, based on a geopositioning device such as a GPS, by state, by an area code or network address, or the like. The location of the customer may be permanent, such as a mailing address on an account, or temporary, such as an IP address.

When the customer is located in a specific geography that is prohibited by the system, the contact is excluded from the contact list. The system may cross-reference a database with geographies that are currently under prohibition from being contacted. After determining the customer or contact's location, the system cross-references the database to determine if the customer or contact's location results in exclusion from the contact list.

In decision block 355, the system determines if an exception is allowed based on geography. As discussed, the exception allows a contact or customer to remain in the pool of customers that are being considered for the contact list. Exceptions that may occur when evaluating customers based on geography include changing conditions in the location, changing rules, and the like. Exceptions from other general categories in the iterative process may also apply with respect to geography. For example, the customer may request a phone call in an area under a geographic restriction, overriding the policy against calling customers in the geographic area based on the customer's request.

In block 360, the system determines contacts that are excluded based on time. In an embodiment, some contacts may only be contacted between certain hours and/or on certain days. For example, phone numbers may only be called between the hours of 9 am and 5 pm on Mondays through Fridays. The time restriction may be based on federal regulations, state regulations, or business policy. In an embodiment, the customer or contact may have multiple times associated with it. For example, a phone number may have an area code in a first time zone and a billing address in a second time zone. The permissible time to call this phone number may be determined as a blend of both time zones, e.g., between 11 am and 3 pm. In another embodiment, the system prevents contact with a customer at a time known to be inconvenient, whether from communication with the customer or in general.

The system determines permissible time to contact based on data associated with the customer, contact, or account. For example, the time zone may be determined based on the billing address, the zip code, a geographic location of the customer based on a geopositioning system in the user's mobile device, an IP address or network address, an input from the user, and the like.

The system determines the user's local time, compares the user's local time to a permissible time to call based on a database of permissible times to call, and excludes customers if the customer is in a time zone that is impermissible to contact at the current time.

In decision block 365, the system determines if an exception is allowed based on time. As discussed, exceptions may be permissible for various reasons, including a request of the customer, a change in time zones of the customer, a change in laws or regulations, and the like. The user of the system may input the exception as a batch process, individually for customers or contacts, or based on other criteria, such as triggers associated with customer accounts. A trigger may be a request for an updated mailing address or the like.

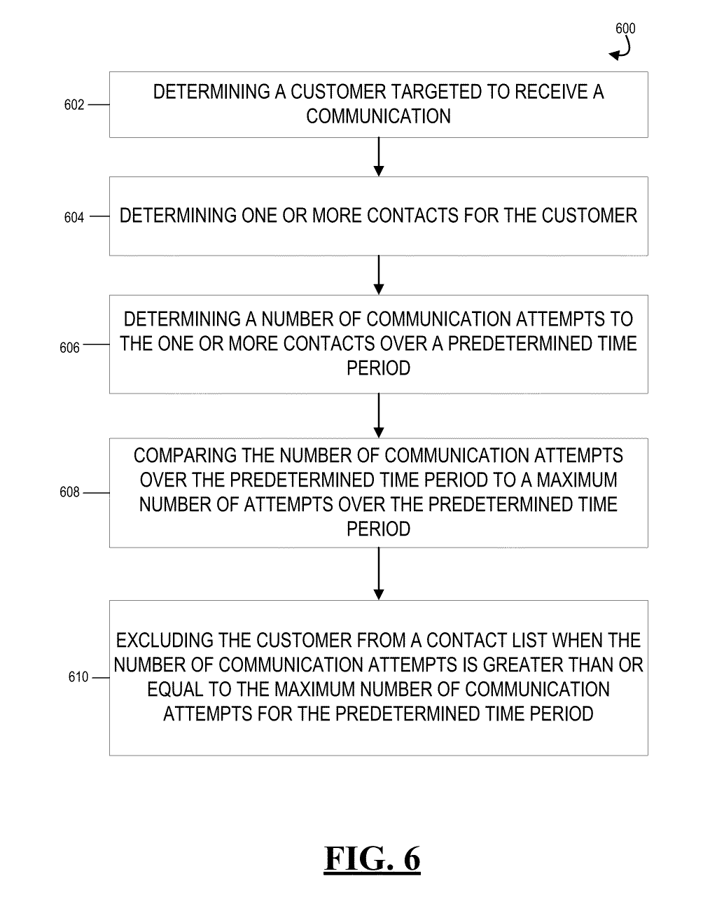

In block 370, the system determines contacts that are excluded based on velocity. As used herein, velocity is a measurement of frequency of contact. As discussed in FIG. 6 and related text, numerous measures of velocity are possible. For example, the number of phone calls in a 24 hr period or the number of phone calls in a day may be measured by the system.

Federal, state, and local authorities may have restrictions on the frequency with which a customer in arrears may be contacted. Additionally, business decisions may control the number of times and/or the frequency with which a customer is contacted at one or more contacts. In an embodiment, an attempted contact is still considered a contact. For example, a phone call to a customer that does not reach the customer is still considered a contact because the missed call shows up on the customer's phone.

The system tracks the frequency of contacts for each customer and compares the frequency to the permissible frequency to determine if the user is at the limit of permissible calls within a predetermined time period. Once the customer has been contacted the permissible number of times in the time period, the customer and all associated contacts are excluded from the contact list until a new time period is considered.

In block 375, the system determines if an exception is allowed based on velocity. The exception may be because the customer requested a call on a more frequent basis or other reasons.

In block 380, the system determines contacts that are excluded based on permission to contact. In some embodiments, the system requires permission to contact a customer before the customer can be added to a contact list. For example, the institution may have a policy that the customer must provide permission before being contacted. In another embodiment, permission is required in order to be contacted via a specific channel, such as social media contacts. In a still further embodiment, permission is required based on federal laws. In 1991, the Telephone Consumer Protection Act (TCPA) was passed by the United Stated Congress and signed into law. One provision of the TCPA prevents automated telephone equipment from dialing any telephone number assigned to a paging service, cellular telephone service, specialized mobile radio service, or other radio common carrier service, or any service for which the called party is charged for the call without the prior express consent of the called party.

The system determines whether permission is required for a customer based on analysis of data associated with the customer and based on the channel via which the customer is being contacted. For example, the system may determine whether permission has been received and whether the contact associated with the selected customer is a contact channel that requires permission. If permission is required but not documented as received by the system, the customer is excluded from the contact list.

In block 385, the system determines if an exception is allowed based on permission to contact. If the restriction on contacting is based on federal laws, then the system will not allow an exception. If the restriction is based on business policy, then the system will prompt the user to enter a reason for the exception and allow the customer to be added to the contact list.

In block 390, the system determines a contact list based on customers that are not excluded based on exclusion criteria. After one or more of the steps in the iterative process completes, the system determines the contact list based on the selected customers meeting the selection criteria and not excluded based on the iterative checks.

The contact list is used to assist automatic dialers and/or manual dialers in communicating with a pool of customers. As discussed, the selection criteria allow the pool of customers to share one or more attributes and be efficiently targeted by representatives of the institution, such as a contact list of customers whose preferred language is Spanish being contacted by Spanish-speaking representatives.

The contact list may be used for a variety of reasons including discussion of accounts in arrears, offers, advertisements, and the like.

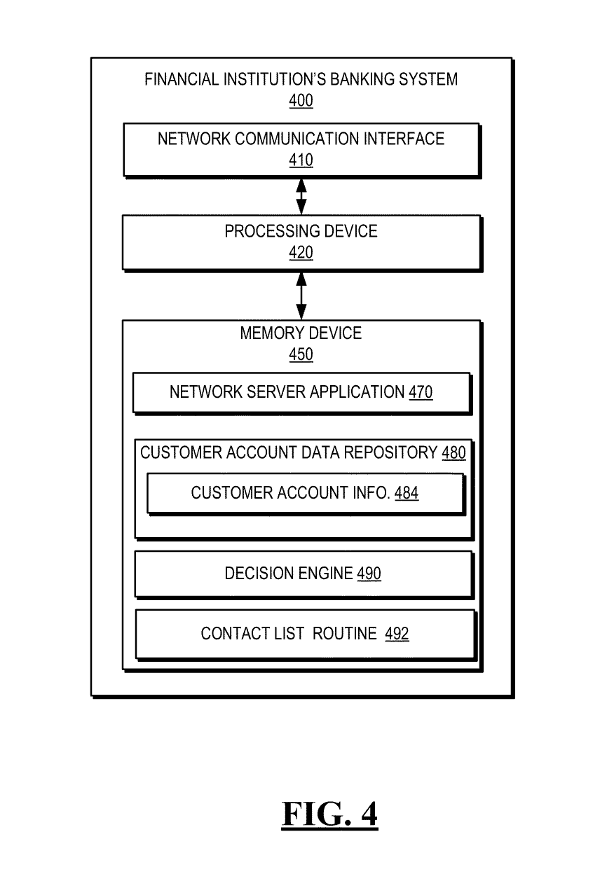

FIG. 4 provides a block diagram illustrating an exemplary financial institution banking system 400 in greater detail, in accordance with embodiments of the invention. The banking system 400 may be the merchant system that provides for the system and method disclosed in FIGS. 1-3. As illustrated in FIG. 4, in one embodiment of the invention, the banking system 400 includes a processing device 420 operatively coupled to a network communication interface 410 and a memory device 450. In certain embodiments, the banking system 400 is operated by a first entity, such as a financial institution, while in other embodiments the banking system 400 is operated by an entity other than a financial institution.

It should be understood that the memory device 450 may include one or more databases or other data structures/repositories. The memory device 450 also includes computer-executable program code that instructs the processing device 420 to operate the network communication interface 410 to perform certain communication functions of the banking system 400 described herein. For example, in one embodiment of the banking system 400, the memory device 450 includes, but is not limited to, a network server application 470, a customer account data repository 480, which includes customer account information 484, a decision engine 490, an contact list routine 492, and other computer-executable instructions or other data. The computer-executable program code of the network server application 470 or the contact list routine 492 may instruct the processing device 420 to perform certain logic, data-processing, and data-storing functions of the banking system 400 described herein, as well as communication functions of the banking system 400.

In an embodiment, the customer account data repository 480 includes customer account information 484. The customer account information may include account history for the customer, demographic information for the customer, any notations made by the customer or a representative on the customer's file, and the like.

In some embodiments, the contact list routine 492 determines a list of selected customers based on selection criteria, conducts the iterative process of evaluating selected customers and excluding customers based on one or more criteria, and determining a contact list. In an embodiment, the contact list routine 492 receives the selection criteria from a user and evaluates the customer information in the customer account data repository 480. The contact list routine 492 then evaluates the customer account information 484 to exclude selected customers as candidates for the contact list, and determines a contact list, as disclosed in FIG. 3.

As used herein, a “communication interface” generally includes a modem, server, transceiver, and/or other device for communicating with other devices on a network, and/or a user interface for communicating with one or more users. Referring again to FIG. 4, the network communication interface 410 is a communication interface having one or more communication devices configured to communicate with one or more other devices on the network, such as a representative work station, an autodialer, a customer contact, and the banking system 400. The processing device 420 is configured to use the network communication interface 410 to transmit and/or receive data and/or commands to and/or from the other devices connected to a network to allow communication between the devices.

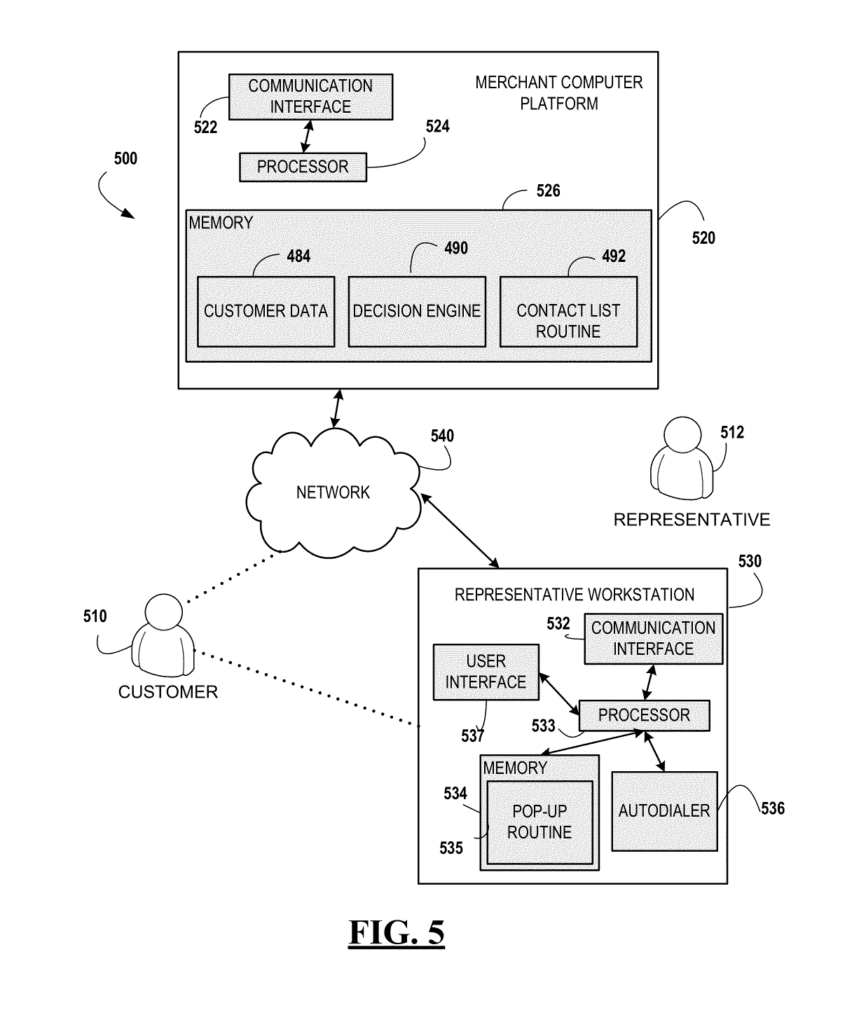

FIG. 5 provides a block diagram illustrating technical components for a system 500 for providing a workflow rules engine, in accordance with an embodiment of the present disclosure. As illustrated, the system 500 includes a customer 510, a merchant computer platform 520, a representative workstation 530 for a representative 512 and a network 540. It will be understood that the representative 512 has access to the representative workstation 530.

As shown in FIG. 5, the merchant computer platform 520 and representative workstation 530 are each operatively and selectively connected to the network 540, which may include one or more separate networks. In addition, the network 540 may include a local area network (LAN), a wide area network (WAN), and/or a global area network (GAN), such as the Internet. It will also be understood that the network 540 may be secure and/or unsecure and may also include wireless and/or wireline technology. The network 540 may be used to communicate with the customer 510 via the contact.

As shown in FIG. 5, in accordance with some embodiments of the present invention, the representative workstation 530 includes a communication interface 532, a processor 533, a memory 534 having a pop-up routine 535 stored therein, an autodialer or a connection to an autodialer 536, and a user interface 537. In such embodiments, the communication interface 532 is operatively and selectively connected to the processor 533, which is operatively and selectively connected to the user interface 537, the memory 534 and the autodialer 536.

The user interface 537 may allow the representative workstation 530 to receive data from the customer 510. In an embodiment, the representative workstation 530 may include any of a number of devices allowing the representative 512 to control the representative workstation 530 and communicate with the customer 510, such as a keypad, keyboard, touch-screen, touchpad, microphone, mouse, joystick, stylus, other pointer device, button, soft key, and/or other input device(s). In some embodiments, the user interface 537 also includes one or more user output devices, such as a display and/or speaker, for presenting information to the representative 512.

Each communication interface described herein, including the communication interface 532 and 522, generally includes hardware, and, in some instances, software, that enables a portion of the system 500, such as the processor 533 to transport, send, receive, and/or otherwise communicate information. For example, the communication interface 532 of the representative workstation 530 may include a modem, server, electrical connection, and/or other electronic device that operatively connects the representative workstation 530 to another electronic device, such as the electronic devices that make up the merchant computer platform 520 and/or the electronic device of the customer 510.

Each processor described herein, including the processor 533 and 524, generally includes circuitry for implementing the audio, visual, and/or logic functions of that portion of the system 500. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as the memory 534 of the representative workstation 530 and the memory 526 of the merchant computer platform 520.

Each memory device described herein, including the memory 534 for storing the pop-up routine 535 and the memory 526 of the merchant computer platform 520, may include any computer-readable medium. For example, memory may include volatile memory, such as volatile random access memory (RAM) having a cache area for the temporary storage of data. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

As shown in FIG. 5, the memory 534 of the representative workstation 530 includes the pop-up routine 535. The pop-up routine 535 provides an opportunity for the representative 512 to enter exceptions to rules that exclude selected customers from the contact list. The pop-up routine 535 also provides alerts and/or information to the representative relating to the customer, the contact, or the call. For example, the pop-up routine may determine that the customer resides in a state having restrictions on certain questions during a phone call from a financial institution. The pop-up routine would display a special screen before or during the communication with the customer providing information on the restrictions. In some embodiments, the pop-up routine 535 includes computer-executable program code portions for instructing the processor 533 to perform one or more of the functions of the pop-up routine 535 described and/or contemplated herein.

It will be understood that the representative workstation 530 can be configured to implement one or more portions of the process flows described and/or contemplated herein. For example, in some embodiments, the representative workstation 530 is configured so that the communication interface 532 is operatively and selectively linked to the merchant computer platform 520 to receive autodialing campaigns or connect to an autodialer. For instance, information regarding the customers that will be contacted during an autodialing campaign, e.g. contacts, account history, or the like. In other embodiments (not shown) an application may be stored in the memory 534 of the representative workstation 530 that enables the workstation to perform some or all of the steps of process flows 300 shown in FIG. 3.

FIG. 5 also illustrates a merchant computer platform 520, in accordance with an embodiment of the present invention. The merchant computer platform 520 may include any computerized apparatus that can be configured to perform any one or more of the functions of the merchant computer platform 520 described and/or contemplated herein. In accordance with some embodiments, for example, the merchant computer platform 520 may include an engine, a platform, a server, a database system, a front end system, a back end system, a personal computer system, and/or the like. In some embodiments, such as the one illustrated in FIG. 5, the merchant computer platform 520 includes a communication interface 522, a processor 524 and a memory 526. In some embodiments, as illustrated in FIG. 5, customer data (such as contacts, transactional data, account history data, social network data and Internet data) 484, a decision engine 490 for evaluating selection criteria, excluding selected customers based on characteristics, and determining contact lists, and an contact list routine 492 may be stored in memory 526. The customer data 484 may have been previously collected and stored in the memory 526 of the merchant computer platform 520, or the merchant computer platform may actively collect customer data 484 by using the communication interface 522 to access the network 540 and only temporarily saves the customer data 484 to the memory to be accessed by the processor 524. The communication interface 522 is operatively and selectively connected to the processor 524, which is operatively and selectively connected to the memory 526.

It will be understood that the merchant computer platform 520 can be configured to implement one or more portions of the process flows described and/or contemplated herein. For example, in some embodiments, the merchant computer platform 520 is configured so that the processor uses a decision engine 490 to determine the contact list and then instructs the autodialer to communicate with the customer on the contact list via the contact. In certain embodiments the contact list routine 492, stored in memory 526, is configured to control an autodialer 536. The autodialer may be integral with the system or may be external to the system yet connected over the network 540.

It will be understood that the embodiment illustrated in FIG. 5 is exemplary and that other embodiments may vary. For example, in some embodiments, some or all of the portions of the system 500 may be combined into single portion. Specifically, in some embodiments, the merchant computer platform 520 is configured to perform all of the same functions of those separate portions as described and/or contemplated herein. Likewise, in some embodiments, some or all of the portions of the system 500 may be separated into two or more distinct portions.

Turning now to FIG. 6, a flow diagram illustrating a process flow for a system and method for determining velocity data is provided, in accordance with an embodiment of the present disclosure. In some embodiments, the system is configured to determine one or more contacts for a customer; determine a number of communication attempts to the one or more contacts over a predetermined time period; compare the number of communication attempts over the predetermined time period to a maximum number of attempts over the predetermined time period; and exclude the customer from a contact list when the number of communication attempts is greater than or equal to the maximum number of communication attempts for the predetermined time period. As used herein, velocity data is synonymous with frequency of attempted contact in a specific period of time. The system allows users to control the number and frequency of attempted contacts to a customer to both comply with business decisions and local regulations. In some embodiments, the system also tracks velocity across customer, account, and/or contact.

In block 602, the system determines a customer targeted to receive a communication. As discussed, in some embodiments, the customer is associated with a financial institution. The customer may have an account or relationship with the institution. For example, the customer may have a credit card or line of credit with the institution. In some embodiments, the institution is communicating with the customer regarding accounts in arrears or discussing recovery of payment in arrears. In further embodiments, the customer is a customer of a third party associated with the institution. For example, the institution may be contracted to communicate with the customer by the third party. In a still further embodiment, the customer is a potential customer of the institution or a third party. The customer may be an individual or an entity such as a business, non-profit, or governmental entity. The customer may have multiple contacts and multiple accounts with the institute.

In an embodiment, a communication is an interaction between the institution and the customer. The communication may be audible and/or visual, such as a phone call, a text message, an instant message, a voicemail message, a direct mailing, a video conference, or the like. The communication may be via a representative of the institution or may be via an automated system, e.g., an automated email system, an automatic dialing system or the like. In an embodiment, the communication is a two-way communication, such as a phone call, but in a further embodiment, the communication is a one-way communication, such as a text message from a source that does not receive responses.

The customer may be targeted for the communication for a variety of reasons. For example, the financial institution may be planning a calling campaign to discuss accounts of customers that share a common characteristic, e.g., three months in arrears or the like. In another embodiment, customers that are eligible for special programs are targeted for a communication disclosing the programs and/or benefits. As should be understood, institution may desire to target one or more customers for a wide variety of reasons. The examples disclosed herein are merely exemplary.

The system may determine the customers based on selection criteria, based on customer request, based on representative request, or based on an external request. For example, in one embodiment, the system determines the customer targeted to receive the communication based on selection criteria. As discussed, selection criteria are one or more criteria that a plurality of customers can be evaluated by to determine whether one or more of the plurality meet the criteria. The criteria can be a single criterion, e.g., having a specific account type, or multiple criteria, e.g., having a specific account type, preferring Spanish-speaking representatives, and eligible for a special program. The selection criteria can be automatically generated based on a model customer, e.g., select customers similar to customer X, or the selection criteria can be input by the institution or by a third party.

In another embodiment, the system determines the customers based on customer request. For example, customers may opt in to receiving one or more communications. By opting in, the customer is requesting that the customer be targeted to receive the communication. The opt in may be specific to a particular communication or program, e.g., communications regarding a specific banking center, or the op in may be general in nature, e.g., any communication from the institution.

In a further embodiment, the system determines the customers based on representative request. For example, a representative may request a specific customer to communicate with or the representative may request one or more customers that have history with the representative. For example, the representative may request a list of all customers that the representative attempted to contact in the previous month but that the representative was not able to speak with over the phone.

In a still further embodiment, the system determines the customers based on the external request. For example, a merchant may desire to communicate to all institution customers that purchased an item in the past year. The institution has records of purchases and can determine the targeted one or more customers based on the merchant's request. The external request may be useful in communicating with customers regarding rebates, sales, loyalty programs, or the like.

In block 604, the system determines one or more contacts for the customer. As discussed, a contact is a piece of information that allows another party to communicate with the customer. In an embodiment, the contact is channel specific. For example, the contact may be a phone number, e.g., a landline or mobile phone number. The system disclosed herein may be used with various types of contacts, including phone numbers for voice or text messaging, email addresses, private messaging address (such as through a web forum, social network messaging, instant messaging, physical mail, in-person contact, messages provided when logging into merchant websites, messages on ATMs or receipts, and the like.

In an embodiment, a customer may have more than one contact in the system. For example, the customer may have one or more phone numbers in the system, e.g., a business number, a land line, and a cell phone number. The customer may also have contacts across channels, such as one or more phone numbers, one or more email addresses, and one or more mailing addresses.

In an embodiment, the contact is determined by evaluating a database or data store wherein contacts are associated with customers and/or accounts. By cross-referencing the customer and/or account name with contacts in the database, the system identifies contacts for the customer. In an embodiment, one or more databases are accessed, such as institution databases, external databases, public information, and the like.

In block 606, the system determines a number of communication attempts to the one or more contacts over a predetermined time period. In an embodiment, the system determines a total number of communication attempts by tracking all of the institution interactions with the customer via the customer's one or more contacts. For example, the system may track the number of time the customer was called, the number of emails sent to the customer, and the number of text messages sent to the customer. In an embodiment, any attempt to contact the customer wherein the attempt is visible to the customer regardless of whether the attempt is successful, e.g., a missed phone call, is counted towards the number of communication attempts. In some embodiments, the number of communication attempts is channel specific, for example, the total number of text messages sent by the financial institution.

In an embodiment, the total number is determined for a predetermined period of time. For example, the total number of attempted contacts over the previous 1 hour, the current hour, the previous 24 hours, the current day, the previous week, the current week, the previous month, and/or the current month may be determined for the customer. In an embodiment, the period of time is determined by a business decision, customer request, or regulation/law. For example, the institution or a third party may determine that the customer should not be contacted more than four times in a 24 hour period. In this example, the system would determine whether the institution has contacted the customer four or more times in the previous 24 hours. A customer may provide a request for a maximum number of contacts in a predetermined period, for example, the customer may request that the institution contact her no more than three times in a year regarding refinancing. The request may be channel specific, e.g., no more than five texts a month.

In a further embodiment, jurisdictions, e.g., towns, counties, states, and countries, may have regulations and/or laws related to the frequency of contact. The predetermined period of time is determined such that the system regulates communication between the institution and the customer in order to comply with all rules, regulations, and laws.

In an embodiment, the system aggregates the total number of attempted contacts by customer. For example, a customer may have multiple accounts with the financial institution. The institution may be individually contacting the customer regarding multiple accounts. For example, the institution may be contacting the customer regarding a special program available for a first account and separately contacting the customer regarding an account in arrears for a second account. The system may aggregate the total number of attempted contacts based on the customer across both accounts and/or contacts.

In a further embodiment, the system aggregates the total number of attempted contacts by account. In an example, an account may have more than one customer, individual, or contact associated with it. For example, the account may be associated with a business entity and may have five individuals as potential contacts associated with the business entity. The system aggregates the number of attempted contacts to all individuals and determines a number based on the aggregate for the account. In this manner, the system may comply with business decisions regarding the frequency with which account issues may be discussed with a customer.

In a still further embodiment, the system aggregates the total number of attempted contacts by contact. For example, the system determines the total number of attempted contacts at a single phone number or email address. In this manner, the system determines if the institution is exceeding channel or contact specific frequencies. It should be understood that a customer may have multiple contacts and in some embodiments the system aggregates the total number of attempted contacts for each contact for the customer.

In some embodiments, the system determines one or more numbers of attempted contacts for the customer, account, and contact in order to comply with business and legal rules. For example, a business rule may be that a customer cannot be contacted more than five times in a 24 hour period and no more than three times via text message in a 24 hour period. The system tracks both the total number of contacts for the customer and the total number of contacts via text message in a 24 hour period.

In block 608, the system compares the number of communication attempts over the predetermined time period to a maximum number of attempts over the predetermined time period. As discussed, the maximum number of attempts over the predetermined time period may be controlled by business rules, customer request, and/or jurisdiction rules, regulations, and laws. The maximum number of attempts may be stored in a database or datastore that is accessible to the system. The database or datastore is accessed prior to contacting a customer and the maximum number is determined, which is then compared to the numbers of attempted contacts in the predetermined period of time.

In block 610, the system excludes the prospective customer from a contact list when the number of communication attempts is equal to or greater than the maximum number of communication attempts for the predetermined time period. The number of communication attempts may be greater than the maximum number of communication attempts if the institution has permission, e.g., permission from the customer, to exceed the maximum number. For example, the customer may request a phone call that would put the number of requests over the maximum number.

When, however, the number of communication attempts is equal to or greater than the maximum number, the system excludes the customer from a contact list. In this manner, the customer is not going to be contacted, either manually or via an automated system. In some embodiments, the exclusion is for a period of time necessary to comply with frequencies rules and regulations. For example, the customer may be placed on a do not call list until the next day if the institution has reached the maximum number of phone calls for the day. The customer is then excluded from being on a contact list for the remainder of the current day.

In some embodiments, the system alerts the representative to the number of previous and/or remaining contacts. For example, when the representative initiates contact with a customer because the frequency has not exceeded the maximum number, the representative may be alerted to the number of times the customer was called in the previous 24 hours, and the number of permissible contacts remaining. For example, if the current communication equals the maximum number of communications but the customer indicates a desire to speak soon, the representative may request permission to exceed the maximum number of contacts. The alert may be visual or audible. For example, the alert may be a pop-up or display on the representative's computer terminal providing the relevant information. In an embodiment, a specific representative may be selected to contact a customer based on the number of contacts remaining in the predetermined period of time. For example, if the customer has only one contact remaining for the next two weeks, a special representative may be selected so that the representative has broad decision-making authority. For example, a supervisor may be selected when only one contact remains for the customer because the supervisor is more likely to be able to resolve the customer's issues than a lower-level representative that may need a supervisor's assistance to handle customer requests.

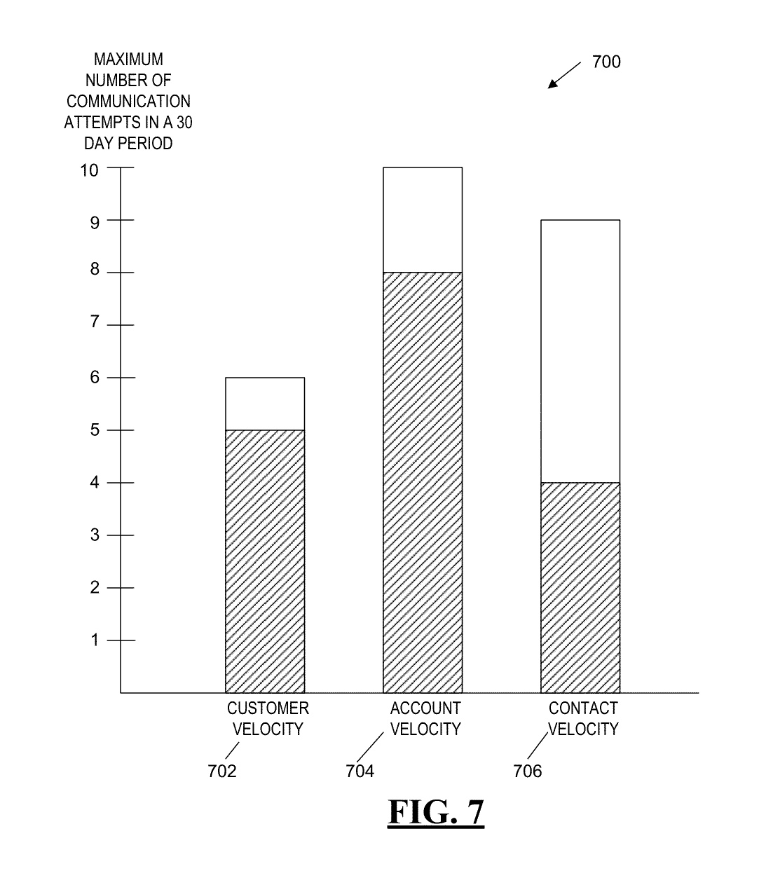

In FIG. 7, a diagram 700 representing exemplary maximum number of communication attempts related to a first customer velocity 702, an account velocity 704, and a contact velocity 706 is provided, in accordance with an embodiment of the disclosure. Customer velocity, account velocity, and contact velocity are measures of frequency of contact, i.e., the number of attempted contacts in a predetermined time period. As discussed, the system may track the number of contacts based on customer, account, and/or contact. In an embodiment, the different measures of velocity may have different total numbers of permissible or maximum contacts in a predetermined time period. In an embodiment, the system tracks each measure of velocity and limits the contacts to the least number of contacts remaining.

For example, as shown in FIG. 7, customer velocity 702, account velocity 704, and contact velocity 706 each have a different number of permissible or maximum communication attempts in a 30 day period. Customer velocity 702 is allowed six attempted contacts within a 30 day period; account velocity is allowed ten attempted contacts within a 30 day period; contact velocity is allowed nine attempted contacts within a 30 day period. These maximums may be determined based on business rules and/or local laws. The diagram also shows the progress towards the maximum for each of customer velocity, account velocity, and contact velocity. For example, a first customer may have been called five times and so has one call remaining The account may be associated with a first customer and a second customer as joint account holders. In this manner, the account velocity at eight attempts may exceed the customer velocity because the institution has contacted the first customer and the second customer, but of which count towards the total number of contacts for the account. Finally, the contact velocity may be the number of times a specific phone number may be called; here, the phone number has been called four times. In an embodiment, the system determines that the first customer may be contacted one more time; the second customer may be contacted two more times (if the customer velocity and contact velocity for the second customer permit it); and the phone number may be contacted five more times. It should be understood that in some circumstances, the institution is limited by the least number of remaining contacts. For example, if the contact is only associated with the first customer and the first customer contact velocity is at the maximum, then the contact will not be used even though attempted contacts are permitted because the customer velocity is at the maximum.

In this manner, the system provides a method for tracking the frequency of attempted contacts to one or more selected customers, while complying with all business decisions and jurisdiction rules, regulations, and laws.

Embodiments of the present invention are described herein with reference to flowchart illustrations and/or block diagrams of methods, apparatus (systems), and computer program products. It may be understood that each block of the flowchart illustrations and/or block diagrams, and/or combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instruction means which implement the function/act specified in the flowchart and/or block diagram block(s).

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

The steps and/or actions of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some embodiments, the processor and the storage medium may reside in an Application Specific Integrated Circuit (ASIC). In the alternative, the processor and the storage medium may reside as discrete components in a computing device. Additionally, in some embodiments, the events and/or actions of a method or algorithm may reside as one or any combination or set of codes and/or instructions on a machine-readable medium and/or computer-readable medium, which may be incorporated into a computer program product.

In one or more embodiments, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer.

Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc”, as used herein, include compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media

Computer program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other updates, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for determining velocity data, the system comprising:
a computer apparatus including a processor and a memory; and
a software module stored in the memory, comprising executable instructions that when executed by the processor cause the processor to:
determine one or more contacts for a customer;
determine a number of communication attempts to the one or more contacts over a predetermined time period;
compare the number of communication attempts over the predetermined time period to a maximum number of attempts over the predetermined time period; and
exclude the customer from a contact list when the number of communication attempts is equal to or greater than the maximum number of communication attempts for the predetermined time period.

2. The system of claim 1, wherein the module is further configured to:
determine a number of attempted contacts for the customer;
determine a number of attempted contacts for an account associated with the communication;
determine a number of attempted contacts for the one or more contacts; and
exclude the customer when any one of the number of attempted contacts for the customer, the number of attempted contacts for the account, and the number of attempted contacts for the one or more contacts is equal to or greater than the maximum number of communication attempts for the predetermined period of time.

3. The system of claim 1, wherein the customer is determined based on selection criteria.

4. The system of claim 1, further comprising executable instructions that when executed by the processor cause the processor to: provide a representative with the number of attempted contacts in the predetermined time period.

5. The system of claim 1, further comprising executable instructions that when executed by the processor cause the processor to: provide a representative with the difference between the number of attempt contacts in the predetermined time period and the maximum number of contacts in the predetermined time period.

6. The system of claim 1, wherein determining that the contact is excluded based on velocity comprises determining a frequency of contact associated with the customer, comparing the frequency of contact associated with the customer with a database of currently prohibited frequencies, and excluding the contact based on the comparison between the frequency of contact of the customer and the database of currently prohibited frequencies.

7. The system of claim 1, wherein the maximum number of communication attempts is determined based on at least one of a business decision and a jurisdictional rule.

8. A computer program product for determining velocity data, the computer program product comprising:
a non-transitory computer readable storage medium having computer readable program code embodied therewith, the computer readable program code comprising:
a computer readable program code configured to determine one or more contacts for a customer;
a computer readable program code configured to determine a number of communication attempts to the one or more contacts over a predetermined time period;
a computer readable program code configured to compare the number of communication attempts over the predetermined time period to a maximum number of attempts over the predetermined time period; and
a computer readable program code configured to exclude the customer from a contact list when the number of communication attempts is equal to or greater than the maximum number of communication attempts for the predetermined time period.

9. The computer program product of claim 8, the computer program product further comprising a computer readable program code configured to determine a number of attempted contacts for the customer; determine a number of attempted contacts for an account associated with the communication; determine a number of attempted contacts for the one or more contacts; and exclude the customer when any one of the number of attempted contacts for the customer, the number of attempted contacts for the account, and the number of attempted contacts for the one or more contacts is equal to or greater than the maximum number of communication attempts for the predetermined period of time.

10. The computer program product of claim 8, wherein the customer is determined based on selection criteria.

11. The computer program product of claim 8, the computer program product further comprising a computer readable program code configured to provide a representative with the number of attempted contacts in the predetermined time period.

12. The computer program product of claim 8, the computer program product further comprising a computer readable program code configured to provide a representative with the difference between the number of attempt contacts in the predetermined time period and the maximum number of contacts in the predetermined time period.

13. The computer program product of claim 8, wherein determining that the contact is excluded based on velocity comprises determining a frequency of contact associated with the customer, comparing the frequency of contact associated with the customer with a database of currently prohibited frequencies, and excluding the contact based on the comparison between the frequency of contact of the customer and the database of currently prohibited frequencies.

14. The computer program product of claim 8, wherein the maximum number of communication attempts is determined based on at least one of a business decision and a jurisdictional rule.

15. A method for determining velocity data, the method comprising:
determining, via a computing device processor, one or more contacts for a customer;
determining, via a computing device processor, a number of communication attempts to the one or more contacts over a predetermined time period;
comparing the number of communication attempts over the predetermined time period to a maximum number of attempts over the predetermined time period; and
excluding the customer from a contact list when the number of communication attempts is equal to or greater than the maximum number of communication attempts for the predetermined time period.

16. The method of claim 15, the method further comprising:
determining a number of attempted contacts for the customer;
determining a number of attempted contacts for an account associated with the communication;
determining a number of attempted contacts for the one or more contacts; and
excluding the customer when any one of the number of attempted contacts for the customer, the number of attempted contacts for the account, and the number of attempted contacts for the one or more contacts is equal to or greater than the maximum number of communication attempts for the predetermined period of time.

17. The method of claim 15, further comprising providing a representative with the difference between the number of attempt contacts in the predetermined time period and the maximum number of contacts in the predetermined time period.

18. The method of claim 15, further comprising providing a representative with the number of attempted contacts in the predetermined time period.

19. The method of claim 15, wherein determining that the contact is excluded based on velocity comprises determining a frequency of contact associated with the customer, comparing the frequency of contact associated with the customer with a database of currently prohibited frequencies, and excluding the contact based on the comparison between the frequency of contact of the customer and the database of currently prohibited frequencies.

20. The method of claim 15, wherein the maximum number of communication attempts is determined based on at least one of a business decision and a jurisdictional rule.
